(19) United States
(12) Patent Application Publication
(10) Pub. No.: US 2024/0009692 A1
(43) Pub. Date: Jan. 11, 2024

(54) DISPENSING DEVICE WITH A HARD-SPOT CHECK VALVE

(71) Applicant: PROMENS SA, BELLIGNAT (FR)

(72) Inventors: Pascal HENNEMANN, VAUX-LES-SAINT-CLAUDE (FR); Gwénaël DOULIN, SAINTE EUPHEMIE (FR)

(21) Appl. No.: 18/188,351

(22) PCT Filed: Aug. 27, 2021
(86) PCT No.: PCT/FR2021/051496

§ 371 Date: Mar. 22, 2023

(30) Foreign Application Priority Data
Sep. 29, 2020 (FR) 2009901

(51) Int. Cl. B05B 11/00; B05B 11/10

(52) U.S. Cl. CPC B05B 11/007; B05B 11/1004; B05B 11/1061; B05B 11/00442; B05B 11/0089

(57) ABSTRACT

The present invention relates to a dispensing device, comprising:
a connecting member to be mounted on the opening of a container,
a piston,
   a cylinder body in which the piston is arranged so as to define a metering chamber between the piston and the cylinder body, the piston comprising a dosing inlet and a dispensing opening, the cylinder body being slidable along the piston,
   an inlet check valve provided to open the dosing inlet when subjected to negative pressure,
   an outlet check valve provided to open the dispensing opening when subjected to positive pressure.

The outlet check valve comprises a membrane with a sealing lip adapted to slide against the inner axial surface of the cylinder body.

### TECHNICAL FIELD OF THE INVENTION

The present invention relates to a device for dispensing a liquid or pasty dispensable, in particular a cream, ointment or paste, in particular for cosmetic use.

More particularly, the present invention relates to a dispensing device for mounting on an opening of a container containing the product to be dispensed, such that the product exits through a dispensing port of the dispensing device from the opening of the container and through the dispensing port.

More particularly, this dispensing device forms a pump with a metering chamber for dispensing a given quantity, corresponding to the volume of this metering chamber and a dead volume.

### TECHNICAL BACKGROUND

Dispensing devices are known in the state of the art which fit onto the neck of a container containing a liquid or cream.

In particular, there are dispensing devices, such as that of FR2848618, comprising two valves: a low valve at the inlet of the metering chamber and a dispensing valve at the dispensing orifice. In this dispensing device, the piston is fixed and the cylinder body is movable. The dispensing valve is formed by a diaphragm with a fixed base which only opens under the internal pressure of the pump.

### SUMMARY OF THE INVENTION

The present invention aims to improve known two-valve dispensing devices, in particular to provide improved vacuum tightness.

The invention provides a device for dispensing a liquid or pasty dispensable, comprising:
a connecting member intended to be mounted on the opening of a container containing the product to be dispensed,
a piston fixedly arranged with respect to the connecting member,
a cylinder body in which the piston is arranged so as to define a metering chamber between the piston and the cylinder body, the piston comprising at least one upstream opening forming an inlet of the metering chamber, the so-called dosing inlet, and the metering chamber comprising a downstream opening, the so-called dispensing opening, the cylinder body being slidably movable along the piston between a deployed position and a retracted position,
an inlet check valve provided to open the dosing inlet when subjected to a negative pressure generated in the metering chamber upon movement of the cylinder body to its extended position,
a outlet check valve provided to open the dispensing opening when subjected to a positive pressure generated in the metering chamber upon movement of the cylinder body to its retracted position, so as to allow the dispensing of a dose of product to be dispensed through the dispensing opening,
characterized in that the outlet check valve comprises a membrane provided with a sealing lip adapted to slide against the inner axial surface of the cylinder body, between an upstream position and a downstream position, in that the inner axial surface of the cylinder body has a sealing seat design to retain the sealing lip axially during a first part of the movement of the cylinder body towards its retracted position, the sealing lip sliding on the sealing seat during a second part of the movement of the cylinder body towards its retracted position.

Thanks to the invention, it is possible to cumulate several advantages that are incompatible with conventional valve systems. Firstly, optimum vacuum tightness is achieved even when the pressure acting on the outlet check valve is subject to pressures above 1 bar. Secondly, the release of excess pressure before the pushbutton is in the down position facilitates priming and reduces the contact force.

The device according to the invention is very compact and requires a reduced number of parts. In addition, it is possible to have a very low dead volume and the priming of the pump is facilitated.

According to further features of the invention:
the sealing seat has a radial shoulder upstream and a downstream portion forming a ramp for the purpose of facilitate upstream sliding of the sealing lip;
the inner axial surface of the cylinder body has an edge, upstream of the sealing seat, which axially retains the sealing lip in its upstream position;
the outlet check valve comprises an elastic return member which biases the membrane towards its upstream position in which the sealing lip is located upstream of the sealing seat;
the elastic return member comprises a base of elastically deformable material which is interposed axially between the membrane and a bottom wall of the cylinder body;
the base is in the form of an inverted bell, the base comprising a central portion which is connected to the membrane and an outer peripheral portion which rests on the bottom wall of the cylinder body, and in that the central portion is mounted so as to be axially movable with the membrane between an upstream position, corresponding to the upstream position of the sealing lip, and a downstream position, corresponding to the downstream position of the sealing lip;
the outer peripheral portion of the base is fitted onto a ferrule formed on the bottom wall of the cylinder body;
the base is made in one piece with the membrane;
The outlet check valve has an axial extension which cooperates with a tubular housing arranged on the bottom wall of the cylinder body so as to axially guide the membrane between its upstream position and downstream position;
the axial extension is made in one piece with the membrane;
the dispensing opening opens into the cylinder body between the free end of the outer peripheral portion of the base and the sealing seat;
the connecting member comprises an annular groove adapted to receive an inner tubular portion belonging to the piston, and in that the annular groove comprises a downstream port which is adapted to communicate with the opening of the container and an upstream port which is adapted to communicate with the exterior of the dispensing device;
the inner tubular portion of the piston comprises an axial skirt capable of deforming within the annular groove between a sealed position in which it obstructs the passage between the downstream port and the upstream port and a vented position in which it allows air to enter the container via the upstream port and the downstream port;
the piston is surmounted by a cylindrical lip to push the membrane when the cylinder body is in the retracted position.

### BRIEF DESCRIPTIONS OF THE FIGURES

Further features and advantages of the invention will become apparent in the course of the following detailed description is intended to help you understand the attached drawings, in which:

FIG. 1 is an exploded perspective view of a pump-type dispensing device according to the invention intended to be fitted to a container containing a liquid or pasty product to be dispensed;

FIG. 2 is an axial cross-sectional view in the 2-2 plane showing the dispensing device according to the invention mounted on the container, before priming the pump;

FIG. 3 is a view similar to FIG. 2 which shows an enlargement of the upper part of the dispensing device according to the invention showing the mounting of the outlet check valve in the cylinder body when in a deployed position;

FIG. 4 is a similar view to FIG. 2 which illustrates a step of operation after the dispensing device has been primed, with the metering chamber containing a dose of product to be dispensed and the diaphragm of the outlet check valve occupying its upstream position;

FIG. 5 is a similar view to FIG. 4 which illustrates a step of operation following the step in FIG. 4 in which the membrane occupies its downstream position;

FIG. 6 is a view similar to FIG. 4 which illustrates an operating step following the step in FIG. 5 in which the outlet check valve occupies its retracted position at the end of the product dispensing phase;

FIG. 7 is a similar view to FIG. 4 which illustrates a step of operation following the step in FIG. 6 in which the diaphragm is again in its upstream position at the start of the upward movement of the cylinder body to its extended position;

FIG. 8 is a view similar to FIG. 4 which illustrates an operating step following the step in FIG. 7 in which the negative pressure produced in the metering chamber by the movement of the cylinder body to its extended position causes a further dose of product to be drawn through the inlet check valve;

FIG. 9 is a similar view to FIG. 3 which shows an enlarged view of the lower part of the dispensing device showing a passage for venting the container when the axial skirt of the piston is in the position of sealing the passage;

FIG. 10 is a similar view to FIG. 9 which illustrates the venting position of the axial piston skirt.

### DETAILED DESCRIPTION OF THE INVENTION

In the following description, identical, similar or analogous elements will be referred to by the same reference numerals.

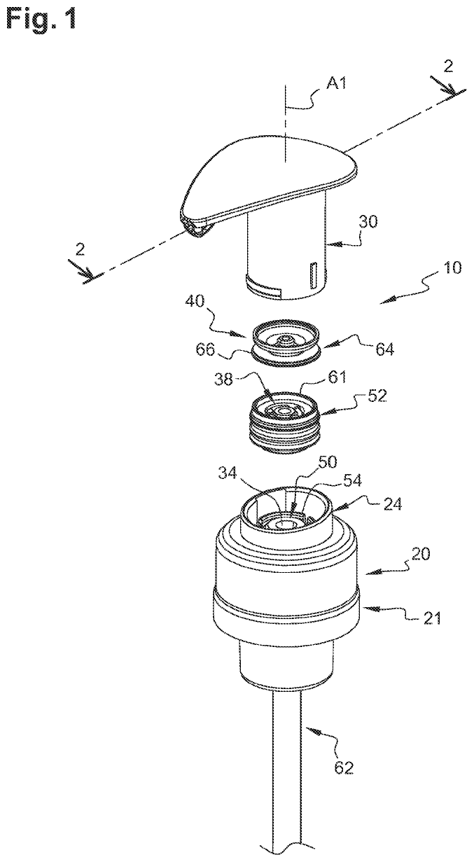

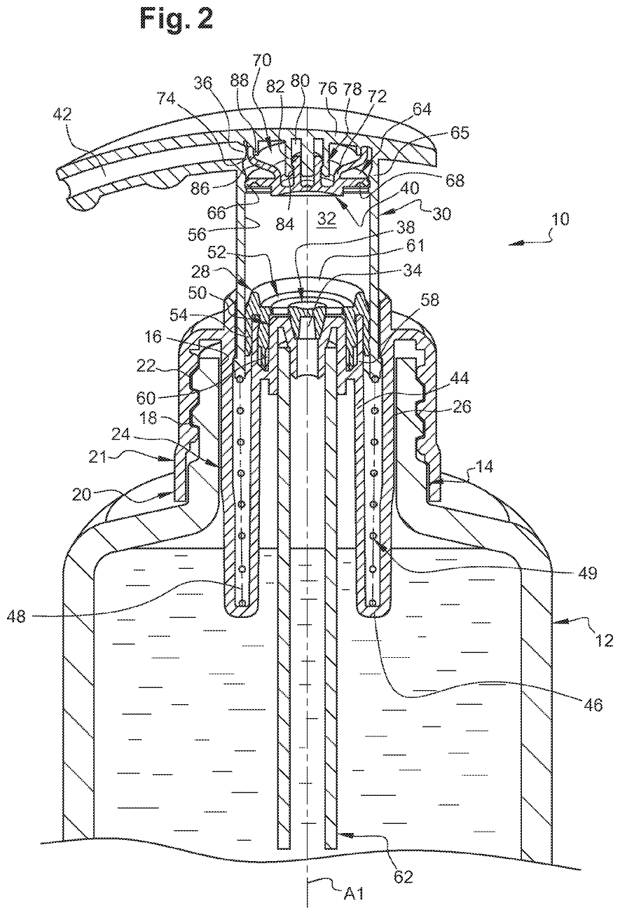

FIGS. 1 and 2 illustrate a dispensing device 10, or pump, which is mounted on a container 12 containing a product to be dispensed such as a paste or liquid, in particular a cosmetic product. The dispensing device 10 and the container 12 extend along a main axis A1 which here extends in a vertical direction when considering FIGS. 1 and 2.

In the remainder of the description, an orientation from upstream to downstream will be used by way of example, considering the direction of flow of the product to be dispensed from the container 12 towards the outlet of the dispensing device 10. The orientation from upstream to downstream corresponds here to an orientation from bottom to top along the main axis A1.

The container 12 is here in the form of a generally cylindrical bottle, of main axis A1, comprising a sleeve 14 delimiting an opening 16 giving access to the product to be dispensed. The sleeve 14 is here provided with nets 18 allowing assembly by screwing with the dispensing device 10.

The dispensing device 10 comprises a connecting member 20 which is provided with a collar 21 defining an internal thread 22 complementary to the nets 18 of the sleeve 14. The connecting member 20 also includes a tubular main body 24, the collar 21 being here made in one piece with an external axial wall 26 of the main body 24.

The dispensing device 10 further comprises a piston 28 which is arranged here within the main body 24 and is fixed relative to the main body 24. The piston 28 is arranged within a cylinder body 30 which is movably mounted relative to the piston 28. The piston 28 defines in the cylinder body 30 a metering chamber 32 which communicates with the container 12 through an upstream opening called the dosing inlet 34 and which communicates with the outside of the control device 10 through a opening 36, at the outlet of the dosing chamber 32.

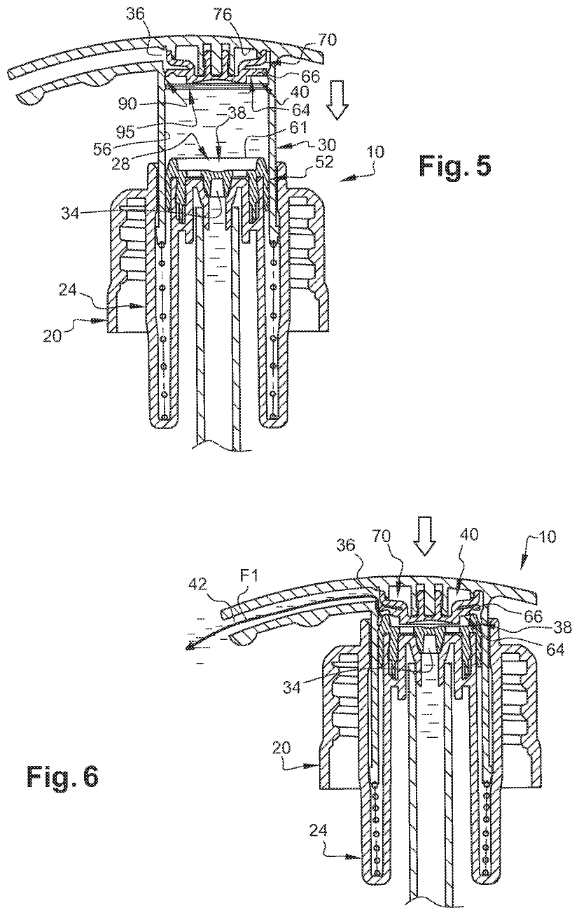

The cylinder body 30 is slidable along the piston 28 between a deployed position, which is shown in FIG. 2, and a retracted position, which is shown in FIG. 5.

The dosing inlet 34 is closed by an inlet check valve 38 which is arranged to open the dispensing opening 34 when subjected to a negative pressure generated in the metering chamber 32 by the movement of the cylinder body 30 to its extended position.

The distribution opening 36 is closed by an outlet check valve 40 which is provided to open the distribution opening 36 when subjected to a positive pressure generated in the metering chamber 32 upon movement of the cylinder body 30 to its retracted position.

In the illustrated embodiment, the distribution opening 36 extends into a dispensing duct 42 which here extends generally transversely to the cylinder body 30.

The piston 28 is here arranged at the upper axial end, or downstream end, of an inner axial wall 44 belonging to the main body 24. The inner axial wall 44 of the main body 24 is here substantially parallel to its outer axial wall 26. The two axial inner 44 and outer 26 walls are connected at their lower axial ends, or upstream ends, by a material bridge 46, and define between them an annular housing 48 able of axially sliding to receive at least a lower part of the cylinder body 30. In addition, an elastic return element 49, here a helical compression spring, is interposed axially between the material bridge 46 and the upstream axial end of the cylinder body 30, so as to urge the cylinder body 30 downstream, here upwards, in the deployed position.

Here, the piston 28 comprises a cylindrical base 50 on which a tubular seal 52 is mounted. The tubular seal 52 comprises here:
an outer tubular portion 54 which is radially compressed between the inner axial surface 56 of the cylinder body 30 and the inner axial wall 44 of the main body 24, and
an inner tubular portion 58 which is axially inserted into an annular groove 60 arranged between the inner axial wall 44 of the main body 24 and the cylindrical base 50 of the piston 28.

Advantageously, the piston 28 may comprise a cylindrical lip 61 on its downstream side. This cylindrical lip 61, which is optional, is intended to cooperate with an element of the outlet check valve 40 as will be explained later.

Here, the dosing inlet 34 opens into the centre of the cylindrical base 50 through the inlet check valve 38. According to the illustrated embodiment, a supply pipe 62 is fitted to the underside of the cylindrical base 50 so as to connect the bottom of the container 12 to the metering chamber 32.

The inlet check valve 38 may be of various forms. For example, it comprises an elastically deformable flexible membrane as described in FR3063661B1. The inlet check valve 38 may be made in one piece with the piston 28, for example in an elastically deformable material of the elastomer type.

Advantageously, the outlet check valve 40 comprises a disc-shaped membrane 64 whose diameter is substantially equal to the inner diameter of the cylinder body 30 so as to close off an upper end section 65 of the cylinder body 30. The metering chamber 32 is thus delimited at the bottom by the piston 28 and at the top by the membrane 64.

The outer peripheral edge of the membrane 64 forms a sealing lip 66 that abuts the inner axial surface 56 of the cylinder body 30. According to the illustrated embodiment, the membrane 64 has a ring groove 68 in its upstream side, in the vicinity of its outer peripheral edge, which forms a thinning of membrane 64. This ring groove 68, together with a recess 69 formed in the outer peripheral edge, delimits the sealing lip 66 and facilitates the deflection of the sealing lip 66 from the rest of the membrane 64. In particular, this ensures optimum and continuous sliding of the sealing lip 66 on the inner axial surface 56.

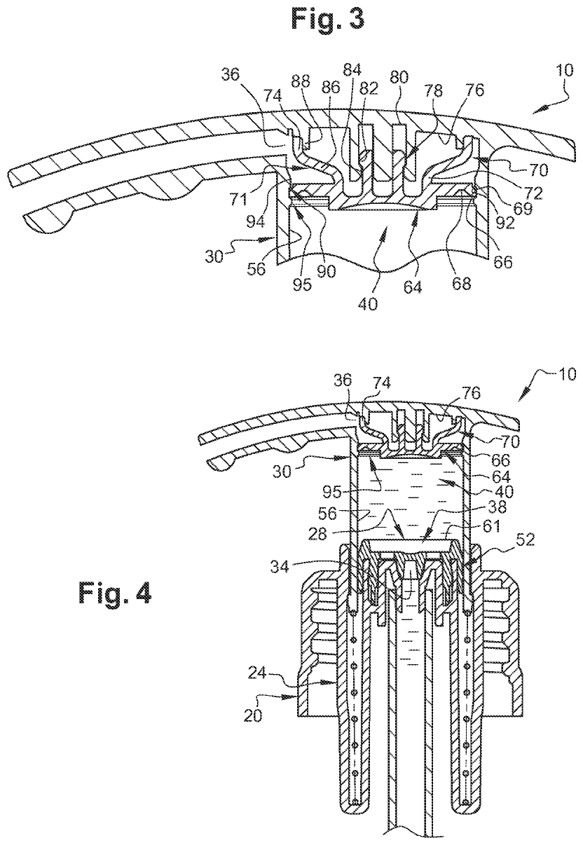

Advantageously, the outlet check valve 40 includes an elastic return member 71 that biases the membrane 64 towards its upstream position illustrated in particular in FIGS. 2 and 3. The elastic return member 71 preferably comprises a base 70 which is interposed axially between the membrane 64 and a bottom wall 76 of the cylinder body 30. The base 70 is generally in the form of an inverted bell, i.e. it flares downstream. The base 70 comprises a central portion 72 which is made in one piece with the downstream face of the membrane 64 and which is extended downstream by an outer peripheral portion 74. The outer peripheral portion 74 comes into axial abutment with the bottom wall 76 of the cylinder body 30.

Advantageously, the outlet check valve 40 also comprises, on the downstream side, a tubular axial extension 78 which is received in a tubular housing 80 complementary to the bottom wall 76 so as to axially guide the membrane 64. According to the illustrated embodiment, the free end of the axial extension 78 is provided with a first peripheral bead 82 which cooperates with a second peripheral bead 84 arranged in the tubular housing 80 so as to axially retain the outlet check valve 40 on the bottom wall 76, in a rest position.

A junction zone 86 located between the central portion 72 and the outer peripheral portion 74 forms a hinge which allows, by elastic deformation, the central portion 72 to bend relative to the outer peripheral portion 74 between an upstream axial position, represented in particular in FIG. 2, and a downstream axial position, represented in particular in FIG. 5. The central portion 72 is here guided in axial sliding by the axial sliding of the axial extension 78 in the tubular housing 80.

The outlet check valve 40 comprising the membrane 64, the base 70 and the axial extension 78 is advantageously made of a single piece of material sufficiently flexible to allow elastic deformation of the base 70 at the junction zone 86, and downstream deformation of the membrane 64 to allow expulsion of a dose of product to be dispensed through the distribution opening 36. The outlet check valve 40 is for example made of an elastomeric material.

Advantageously, the bottom wall 76 comprises a ferrule 88 onto which the outer peripheral portion 74 is fitted, thereby retaining the base 70 on the bottom wall 76, in particular radially.

Advantageously, the inner axial surface 56 of the cylinder body 30 includes a sealing seat 90 provided to axially retain the sealing lip 66 in a downstream direction. The sealing seat 90 is here in the form of a radial shoulder 92 facing upstream. Preferably, the sealing seat 90 extends downstream through a ramp 94 corresponding here to a progressive thinning of the axial wall of the cylinder body 30.

Preferably and optionally, the inner axial surface 56 of the cylinder body 30 includes a edge 95, or upstream sealing seat, which is provided to axially retain the sealing lip 66 in an upstream direction. Thus, the edge 95 defines axially with the sealing seat 90 a groove suitable for receiving the sealing lip 66 when the membrane 64 is in its upstream axial position.

In FIGS. 2, 3 and 4, the membrane 64 is shown in an upstream axial position which corresponds to a rest position, i.e. the outlet check valve 40 is not deformed, and the sealing lip 66 is received in the groove formed by the edge 95 and the sealing seat 90.

In FIG. 5, the membrane 64 is shown in a downstream axial position which corresponds to a retracted position of the membrane 64, i.e. the outlet check valve 40 is compressed with the central portion 72 having slid downstream. In the downstream axial position of the membrane 64, the sealing lip 66 is offset axially downstream from the sealing seat 90.

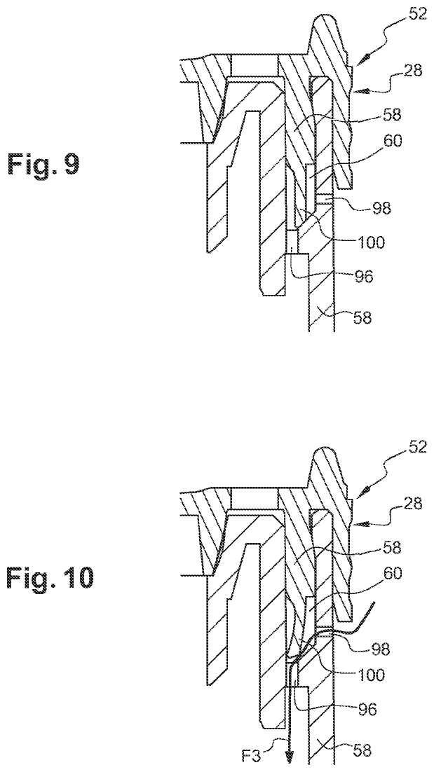

In FIG. 9, the annular groove 60 in which the tubular seal 52 is inserted is shown in an enlarged manner in order to describe a solution for venting the dispensing device 10 and the container 12. According to this advantageous embodiment, the bottom of the annular groove 60 is provided with a first opening, referred to as the downstream port 96, with reference to the direction of suction of the air from the outside to the inside of the container 12, which communicates downstream with the inside of the container 12 and upstream with the annular groove 60. In addition, the inner axial wall 44 of the main body 24 comprises a second orifice, referred to as the upstream port 98, which communicates, downstream, with the annular groove 60 and, upstream, with the housing 48. The upstream port 98 is here arranged close to the bottom of the annular groove 60.

Optionally, the dispensing device 10 may comprise a plurality of downstream port 96 and/or a plurality of upstream port 98. These ports may, for example, be circumferentially distributed around the main axis A1.

Advantageously, the inner tubular portion 58 of the tubular seal 52 terminates upstream, here downstream, in a thinned free end section forming an axial skirt 100. The axial skirt 100 is designed to occupy a closed position, which is shown in FIG. 9, in which it bears against a wall of the bottom of the annular groove 60, and a vented position, which is shown in FIG. 10, in which it frees a passage between the downstream port 96 and the upstream port 98. In its closed position, the axial skirt 100 is in sealing contact with the bottom wall of the annular groove 60, so as to obstruct any passage of air or product between the downstream port 96 and the upstream port 98. In its vented position, the axial skirt 100 is elastically deformed inwards, i.e. towards the main axis A1, under the effect of a flow of air which enters the container through the downstream 96 and upstream 98 ports. The venting position corresponds to an operating phase of the dispensing device 10 which will be explained later.

The operation of the dispensing device 10 according to the invention is now described by considering different operating steps illustrated in particular by FIGS. 4 to 8.

FIG. 4 illustrates the dispensing device 10 after the pump has been primed, with a dose of product already contained in the metering chamber 32. In the configuration shown in FIG. 4, the cylinder body 30 is in its extreme downstream position, i.e. its deployed position. The two check valves 38, 40 are closed, the pressure in the metering chamber 32 and the pressure in the container 12 being substantially equal to the pressure outside the dispensing device 10, typically equal to atmospheric pressure.

The cylinder body 30 behaves in relation to the main body 24 and the piston 28 as a push button. Also, in order to cause the product dose to be dispensed through the outlet opening 36, it is necessary to exert an axial pressure on the upstream-directed bottom wall 76 against the elastic restoring force produced by the elastic return element 49.

During a first phase of the movement of the cylinder body 30, the sealing lip 66 comes to rest axially against the sealing seat 90. The sealing seat 90 thus creates a “hard point” to be passed in the movement of the cylinder body 30. It is therefore necessary to exert a force of sufficient intensity on the cylinder body 30 to pass the “hard point”.

When the force is sufficient, in a second phase of the movement of the cylinder body 30, the sealing lip 66 slides over the sealing seat 90 moving axially downstream with the diaphragm 64 until the diaphragm 64 occupies its downstream position shown in FIG. 5. This movement of the diaphragm 64 to its downstream position is enabled by the deformation of the base 70 at the junction zone 86, with the central portion 72 moving axially downstream relative to the outer peripheral portion 74.

At this stage, dispensing of the product dose has not yet commenced, with the membrane 64 still blocking the passage to the distribution opening 36.

As the axial support on the cylinder body 30 continues, the pressure exerted by the dose of product contained in the metering chamber 32 on the diaphragm 64 is such that the diaphragm 64 eventually flexes by elastically deforming, thus allowing the dose of product to pass between the sealing lip 66 and the inner axial surface 56 of the cylinder body 30, as illustrated in FIG. 6. Arrow F1 illustrates the path of the product to be dispensed from the metering chamber 32 to the dispensing duct 42 through the distribution opening 36.

It is noted that, during the priming phase and in the event that the membrane 64 and its sealing lip 66 have not passed the sealing seat 90 by simple internal pressure, the cylindrical lip 61 located on the piston 28 pushes the membrane 64 and forces the latter to open.

The complete dispensing of the product dose is completed when the membrane 64 comes to rest axially against the piston 28 and returns to its closed position. In the extreme retracted position of FIG. 6, the majority of the cylinder body 30 is received in the annular housing 48 and the elastic return element 49 is maximally compressed.

When the cylinder body 30 reaches the extreme retracted position of FIG. 6, the cylindrical lip 61 mechanically pushes the membrane 64 of the outlet check valve 40 downstream which, in particular, makes a subsequent air priming phase reliable.

Throughout the movement of the cylinder body 30 from its extended position to its retracted position, the inlet check valve 38 remains closed, as does the axial skirt 100 which occupies its closed position.

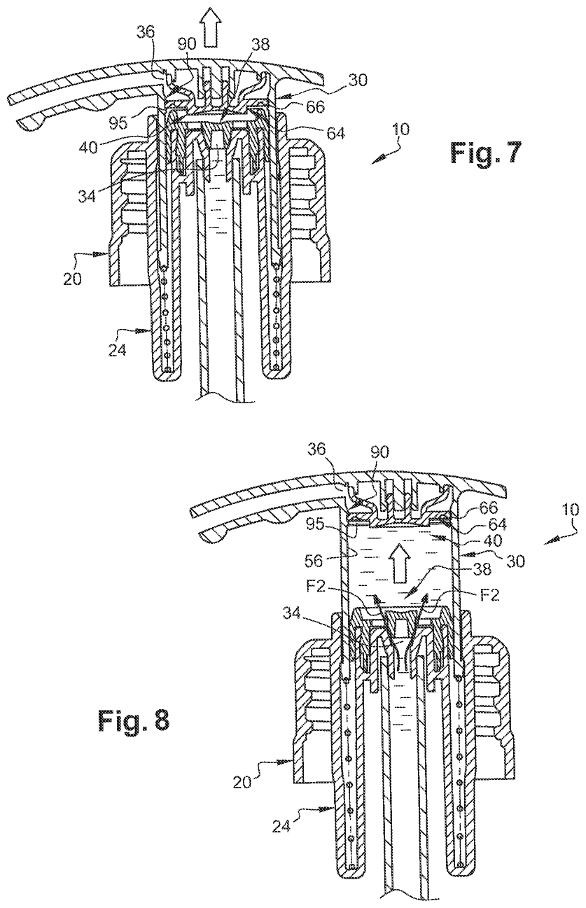

From the extreme retracted position in FIG. 6, when the pressure on the cylinder body 30 is released, the elastic return element 49 pushes the cylinder body 30 downstream, i.e. towards its deployed position. During a first part of the downstream stroke of the cylinder body 30, the outlet check valve 40 first returns to its initial configuration, with the sealing lip 66 passing the sealing seat 90 in the opposite direction, in particular sliding on the ramp 94, until it occupies the axial position shown in FIG. 7, which corresponds to a closed position of the outlet check valve 40.

The cylinder body 30 then continues to move axially downstream causing a vacuum in the metering chamber 32. The sealing lip 66 then comes to rest on the lower sealing seat edge 95, thereby preventing the sealing lip 66 from opening upstream under the vacuum in the metering chamber 32. This vacuum causes the inlet check valve 38 to open, allowing the product to be drawn through the supply pipe 62 and refilling the metering chamber 32, as shown in FIG. 8 and by the arrows F2.

As product is drawn into the container 12, a vacuum is simultaneously created in the container 12. Under the effect of the negative pressure in the container 12, air from outside the dispensing device 10 is drawn in through the downstream port 96 and the upstream port 98. This suction of air F3 is enabled by the deflection of the axial skirt 100 at the upstream port 98 and the downstream port 96, as illustrated by the FIG. 10. This temporary venting allows the pressure to be equalized between the inside of the container 12 and the outside.

The cylinder body 30 finally reaches its extreme downstream position, or deployed position, which is illustrated in FIG. 4, in which the dispensing device is ready to dispense a new dose of product. In this deployed position, the axial skirt 100 returns to its closed position.

The dispensing device 10 according to the invention has the advantage that it can withstand a pressure in the metering chamber 32 of more than 1 bar, with a vacuum seal that does not require locking.

Indeed, the pumps must remain leakproof when subjected to a pressure difference with respect to the outside: vacuum (in an aeroplane or in the mountains) or pressure on the bottle (increase in the temperature of the bottle or pressure from other items during races for example). The classic validation test is a vacuum at −800 mbar. Mechanical valve pumps have this sealing function but at the cost of high-pressure losses and additional parts. Pumps with a deformable valve (membrane) usually do not have this function and must have an additional locking device (static by back pressure or movable when locked) The invention combines the performance of the mechanical valve with the simplicity of the membrane valve.

The configuration of the outlet check valve 40 with the sealing seat 90 provides for enhanced sealing of the metering chamber 32. Thus, the sealing objective of the outlet check valve 40 is to obtain a vacuum water tightness at −800 mbar. This is made possible in particular by the use of a double axial and radial seal at the sealing lip 66 with the sealing seat 90 which represents a hard point to pass and therefore a certain force to guarantee the −800 mbar vacuum. When the outlet check valve 40 deforms under pressure, it reinforces its sealing initially in contact with the sealing seat 90 and then, under mechanical stress, it passes over the sealing seat 90.

The arrangement of the axial skirt 100 with the upstream 96 and downstream 98 ports allows both a good sealing of the container 12 and a venting during the filling of the metering chamber 32 so as to prevent the container 12 from collapsing on itself under the effect of the pressure differential between the inside of the container 12 and the outside.

Furthermore, the dispensing device 10 according to the invention requires a very small number of parts (5 parts), which in particular minimizes the total weight of the device.

The dispensing device 10 according to the invention also has the advantage of minimizing the dead volume, i.e. the stroke of the cylinder body 30 before product is dispensed, and to allow very easy priming during the first product dispensing.

The dispensing device 10 according to the invention can be used with standard container 12 collar.

### LIST OF REFERENCES

10: dispensing device
12: container
14: sleeve
16: opening
18: nets
20: connecting member
21: collar
22: internal thread
24: main body
26: external axial wall
28: piston
30: cylinder body
32: metering chamber
34: dosing inlet
36: dispensing opening
38: inlet check valve
40: outlet check valve
42: dispensing duct
44: inner axial wall
46: material bridge
48: annular housing
49: elastic return element
50: cylindrical base
52: tubular seal
54: outer tubular portion
56: inner axial surface
58: inner tubular portion
60: annular groove
61: cylindrical lip
62: supply pipe
64: membrane
65: upper end section
66: sealing lip
68: ring groove
69: recess
70: base
71: elastic return member
72: central portion
74: outer peripheral portion
76: bottom wall
78: axial extension
80: tubular housing
82: first peripheral bead
84: second peripheral bead
86: Junction zone
88: ferrule
90: sealing seat
92: radial shoulder
94: ramp
95: edge
96: downstream port
98: upstream port
100: axial skirt
A1: main axis of the container and dispensing device

1. A dispensing device for a liquid or pasty dispensable, comprising:
a connecting member intended to be mounted on the opening of a container containing the product to be dispensed,
a piston fixedly arranged with respect to the connecting member,
a cylinder body in which the piston is arranged so as to define a metering chamber between the piston and the cylinder body, the piston comprising at least one upstream opening forming an inlet of the metering chamber, the so-called dosing inlet, and the metering chamber comprising a downstream opening, the so-called dispensing opening, the cylinder body being slidably movable along the piston between a deployed position and a retracted position,
an inlet check valve provided to open the dosing inlet when subjected to a negative pressure generated in the metering chamber upon movement of the cylinder body to its extended position,
an outlet check valve provided to open the dispensing opening when subjected to a positive pressure generated in the metering chamber upon movement of the cylinder body to its retracted position, so as to allow the dispensing of a dose of product to be dispensed through the dispensing opening, characterized in that the outlet check valve comprises a membrane provided with a sealing lip adapted to slide against the inner axial surface of the cylinder body, between an upstream position and a downstream position, in that the inner axial surface of the cylinder body has a sealing seat designed to retain the sealing lip axially during a first part of the movement of the cylinder body towards its retracted position, the sealing lip sliding on the sealing seat during a second part of the movement of the cylinder body towards its retracted position.

2. Dispensing device according to claim 1, characterized in that the sealing seat has a radial shoulder upstream and a downstream portion forming a ramp for the purpose of facilitate upstream sliding of the sealing lip.

3. Dispensing device according to claim 1, characterized in that the inner axial surface of the cylinder body has an edge, upstream of the sealing seat, which axially retains the sealing lip in its upstream position.

4. Dispensing device according to claim 1, characterized in that the outlet check valve comprises an elastic return member which biases the membrane towards its upstream position in which the sealing lip is located upstream of the sealing seat.

5. Dispensing device according to claim 4, characterized in that the elastic return member comprises a base of elastically deformable material which is interposed axially between the membrane and a bottom wall of the cylinder body.

6. Dispensing device according to claim 5, characterized in that the base is in the form of an inverted bell, the base comprising a central portion which is connected to the membrane and an outer peripheral portion which rests on the bottom wall of the cylinder body, and in that the central portion is mounted so as to be axially movable with the membrane between an upstream position, corresponding to the upstream position of the sealing lip, and a downstream position, corresponding to the downstream position of the sealing lip.

7. Dispensing device according to claim 6, characterized in that the outer peripheral portion of the base is fitted onto a ferrule formed on the bottom wall of the cylinder body.

8. Dispensing device according to claim 5, characterized in that the base is made in one piece with the membrane.

9. Dispensing device according to claim 1, characterized in that the outlet check valve has an axial extension which cooperates with a tubular housing arranged on the bottom wall of the cylinder body so as to axially guide the membrane between its upstream position and its downstream position.

10. Dispensing device according to claim 9, characterized in that the axial extension is made in one piece with the membrane.

11. Dispensing device according to claim 1, characterized in that the dispensing opening opens into the cylinder body between the free end of the outer peripheral portion of the base and the sealing seat.

12. Dispensing device according to claim 1, characterized in that the connecting member comprises an annular groove adapted to receive an inner tubular portion belonging to the piston, and in that the annular groove comprises a downstream port which is adapted to communicate with the opening of the container and an upstream port which is adapted to communicate with the exterior of the dispensing device.

13. Dispensing device according to claim 12, characterized in that the inner tubular portion of the piston comprises an axial skirt capable of deforming within the annular groove between a sealed position in which it obstructs the passage between the downstream port and the upstream port and a vented position in which it allows air to enter the container via the upstream port and the downstream port.

14. Dispensing device according to claim 1, characterized in that the piston is surmounted by a cylindrical lip to push the membrane when the cylinder body is in the retracted position.
